(19) United States
(12) Patent Application Publication
(10) Pub. No.: US 2009/0280993 A1
(43) Pub. Date: Nov. 12, 2009

(54) Method of Analyzing the Accuracy of a Sequence of Probe Nucleic Acid Immobilized on a Microarray Substrate

(76) Inventor: Joowon Rhee, Seoul (KR)

Correspondence Address: F. CHAU & ASSOCIATES, LLC, 130 WOODBURY ROAD, WOODBURY, NY, 11797, US

(21) Appl. No.: 12/371,340

(22) Filed: Feb. 13, 2009

(30) Foreign Application Priority Data
May 7, 2008 (KR) 10-2008-0042448

(51) Int. Cl. C40B 20/04

(52) U.S. Cl. 506/4

(57) ABSTRACT

A method of analyzing an accuracy of a sequence of a probe nucleic acid immobilized in a microarray includes providing a microarray in which regions where a probe nucleic acid is immobilized on a substrate are arrayed, hybridizing the probe nucleic acid with a target nucleic acid that is complementary to the probe nucleic acid to form a hybridization product, wherein the target nucleic acid is labeled with a detectable signal material on at least one end, reacting the hybridization product with an enzyme to remove the detectable signal material from the target nucleic acid, wherein the at least one end of the target nucleic acid remains unpaired with the probe nucleic acid, measuring a residual signal generated from the resultant enzyme reaction product, comparing the measured signal value with a signal value generated from a control group experiment; and analyzing an accuracy of the probe nucleic acid sequence.

### CROSS-REFERENCE TO RELATED PATENT APPLICATIONS

This application claims priority from Korean Patent Application No. 10-2008-0042448, filed on May 7, 2008, in the Korean Intellectual Property Office, the contents of which are herein incorporated by reference in their entirety.

### BACKGROUND OF THE INVENTION

1. Field

The present disclosure is directed to a method of analyzing the accuracy of the sequence of a probe nucleic acid immobilized on a microarray.

2. Description of the Related Art

In nucleic acid microarrays, regions where nucleic acids are immobilized on a substrate are arrayed in high density. Microarrays are well known in the art, and are disclosed in, for example, U.S. Pat. No. 5,445,934 and U.S. Pat. No. 5,744,305. Microarrays can be prepared by photolithography, which is also known in the art. In a method of preparing a nucleic acid microarray by photolithography, the steps of exposing to an energy source a selected area of a substrate coated with a monomer protected with a removable group to remove the removable group from the monomer and coupling the resultant unprotected monomer with a monomer protected with a removable group are repeatedly performed. In this method, the nucleic acid immobilized on the selected area is synthesized by elongating the monomer or the previously elongated nucleic acid step by step. On the other hand, in a method of preparing a microarray by spotting, prepared nucleic acids are immobilized on a predetermined area. The spotting method is disclosed in U.S. Pat. No. 5,744,305, U.S. Pat. No. 5,143,854, and U.S. Pat. No. 5,424,186. These patent references relating to a nucleic acid microarray and a method of preparing the same are herein incorporated by reference in their entireties.

According to a conventional technique, nucleic acids are synthesized on a substrate in situ by photolithography, or prepared nucleic acids are immobilized on a substrate after the nucleic acids are prepared in a liquid or solid phase. The method for synthesizing a nucleic acid on the substrate in situ, such as a photolithography can be used to produce a microarray having discrete regions immobilized with the nucleic acids in high density, but it is challenging to analyze accuracy of the length or sequence of synthesized nucleic acids. The synthesis accuracy of probe nucleic acids can be represented by Pⁿ where P denotes a probability that a nucleotide is accurately incorporated into the primer or previously elongated nucleic acid and n denotes the length of the nucleic acids. Accordingly, as the length of a nucleic acid increases, it is more likely that the nucleic acid itself is defective. Due to this situation, the sequence and length of synthesized nucleic acids should be checked for accuracy.

### SUMMARY OF THE INVENTION

According to an embodiment of the present invention, there is provided a method of analyzing accuracy of the sequence of a probe nucleic acid immobilized in a microarray, the method comprising: providing a microarray in which regions where a probe nucleic acid is immobilized on a substrate through a 3′ end or a 5′ end are arrayed; hybridizing the probe nucleic acid with a target nucleic acid that is complementary to the probe nucleic acid to form a hybridization product, wherein the target nucleic acid is labeled with a detectable signal material at at least one end selected from a group comprising a 3′ end and a 5′ end; reacting the hybridization product with at least one enzyme selected from 3′ exonuclease and 5′ exonuclease to remove the detectable signal material from the at least one end of the target nucleic acid, wherein the at least one end of the target nucleic acid remains unpaired with the probe nucleic acid; measuring a residual signal generated from the resultant enzyme reaction product, comparing the measured signal value with a signal value generated from a control group experiment, and analyzing the accuracy of the probe nucleic acid sequence.

### BRIEF DESCRIPTION OF THE DRAWINGS

FIG. 1 is a schematic view in which a signal material attached to 3′ overhang is removed by an exonuclease.

FIG. 2A shows fluorescence measurement results of a control microarray.

FIG. 2B shows fluorescence measurement results of a microarray treated with T4 DNA polymerase.

FIG. 3 is a graph of a T4 DNA polymerase treatment effect with respect to the spotting concentration and length of probe nucleic acids, based on the results shown in FIG. 2B.

FIGS. 4A and 4B show a change in fluorescence intensity before and after a T4 DNA polymerase treatment.

### DETAILED DESCRIPTION OF EXEMPLARY EMBODIMENTS

Exemplary embodiments of the present inventive concept will now be described more fully with reference to the accompanying drawings, in which exemplary embodiments of the invention are shown.

An exemplary embodiment of the present invention provides a method of analyzing the accuracy of the sequence of a probe nucleic acid immobilized in a microarray. The method includes providing a microarray in which regions where a probe nucleic acid is immobilized on a substrate through a 3′ end or a 5′ end are arrayed and hybridizing the probe nucleic acid with a target nucleic acid that is complementary to the probe nucleic acid to form a hybridization product. The target nucleic acid is labeled with a detectable signal material with at least one end selected from the group comprising a 3′ end and a 5′ end. The hybridization product is then reacted with at least one enzyme selected from the 3′ exonuclease and the 5′ exonuclease to remove the detectable signal material from the at least one end. The at least one end of the target nucleic acid remains unpaired with the probe nucleic acid. A residual signal generated from the resultant enzyme reaction product is measured and compared with a signal value generated from a control group experiment, and the accuracy of the probe nucleic acid sequence is analyzed.

A method according to an embodiment of the present invention includes providing a microarray in which regions where a probe nucleic acid is immobilized on a substrate through a 3′ end or a 5′ end are arrayed. The microarray comprises an array of discrete regions where a probe nucleic acid is immobilized on a substrate at the 3′ end or 5′ end. The regions are arrayed in high density. For example, the density of the regions may be 400/cm² or higher, 10³/cm², or 10⁴/cm². A probe nucleic acid can be synthesized on a substrate in situ by photolithography (see U.S. Pat. No. 5,744,305, U.S. Pat. No. 5,143,854 and U.S. Pat. No. 5,424,186), or, after a probe nucleic acid is synthesized in a liquid or solid phase, the probe nucleic acid can be immobilized on the substrate by spotting (see, for example, Stimpson et al., Proc. Nati. Acad. Sci. USA 92:6379-6383,1995). Methods of preparing a nucleic acid in a liquid or solid phase are well known. When a probe nucleic acid is synthesized by photolithography, such regions can be arrayed in high density but the accuracy of the sequence of the synthesized probe nucleic acid may not be guaranteed. On the other hand, when the probe nucleic acid is synthesized in a liquid or solid phase, the accuracy of the probe nucleic acid may be guaranteed but when the probe nucleic acid is immobilized by, for example, spotting, the density of the arrayed regions may be low.

In an embodiment of the present invention, the probe nucleic acid may be immobilized on a substrate at the 3′ end, and the 5′ end of the probe nucleic acid may be exposed. In another embodiment of the present invention, the probe nucleic acid may be immobilized on a substrate at the 5′ end, and the 3′ end of the probe nucleic acid may be exposed.

The probe nucleic acid may be DNA, RNA, or PNA. The length of each of the probe nucleic acid and the target nucleic acid may be in a range of about 4 to about 200 bp, about 4 to about 100 bp, about 4 to about 50 bp, about 4 to about 30 bp, about 4 to about 20 bp, about 4 to about 15 bp, about 10 to about 30 bp, about 10 to about 20 bp, or about 15 to about 30 bp.

A method according to an embodiment of the present invention also includes hybridizing the probe nucleic acid with a target nucleic acid that is complementary to the probe nucleic acid to form a hybridization product. The target nucleic acid is labeled with a detectable signal material with at least one end selected from the group comprising a 3′ end and a 5′ end. The detectable signal material may be any signal material that is known in the art. For example, the detectable signal material may be selected from a fluorescent material or a radioactive material. The detectable signal material may include a signal generating material and a quencher, and at least one end of the 3′ and 5′ ends of the target nucleic acid can be labeled with the signal generating material and the other end can be labeled with the quencher. When the quencher is removed by the exonuclease, a signal may be generated. Examples of the quencher and the signal generating material will be described in detail below.

The target nucleic acid may be labeled with the signal material. The signal material can be labeled at the 3′ end. The signal material can also be labeled at the 5′ end. Specifically, in an embodiment of the present invention, the 3′ end of the target nucleic acid may be labeled with the quencher and the 5′ end of the target nucleic acid may be labeled with the signal generating material, and in another embodiment of the present invention, the 3′ end of the target nucleic acid may be labeled with the signal generating material and the 5′ end of the target nucleic acid may be labeled with the quencher. Thus, when the 3′ end nucleotide or 5′ end nucleotide is cleaved by 3′ exonuclease or 5′ exonuclease, the signal material or the quencher can be removed.

The target nucleic acid with which at least one end selected from the 3′ end or 5′ end is labeled with a quencher and the other end is labeled with a signal generating material may be a self-quenching fluorescent target nucleic acid that includes a fluorescent dye and a quencher. In the self-quenching fluorescence target nucleic acid, there are a pair of labels including a fluorescent dye and a quencher which interact by a fluorescence resonance energy transfer (FRET).

The label comprises any moiety that can be attached to an oligonucleotide, a nucleotide, or a nucleotide 5′-triphosphate and functions to: (1) provide a detectable signal; (2) interact with a second label to modify the detectable signal provided by the label, for example, FRET; and (3) stabilizes hybridization, i.e., duplex formation.

The term “quenching” refers to a decrease in fluorescence of a fluorescent dye caused by a quencher regardless of the mechanism. The “self-quenching” refers to an intramolecular, energy transfer effect, such as FRET. That is, a fluorescence dye and a quencher are attached to a probe nucleic acid in a configuration that permits energy transfer from the fluorescent dye to the quencher, resulting in a reduction of the fluorescence by the fluorescent dye. The self-quenching effect may be diminished or lost upon hybridizatin of the probe to its complement, or upon 5′ nuclease cleavage whereupon the fluorescent dye and the quencher are separated.

The fluorescent dye may be a xanthene dye such as fluorescein. The fluorescent dye may be spaced apart from the quencher by a distance of about 12 nt or more. The fluorescent dye may bind to the 5′ end or 3′ end of the target nucleic acid and the quencher may bind to the other end of the target nucleic acid. For example, the fluorescent dye may bind to a 5′ nucleotide of the target nucleic acid and the quencher may bind to a 3′ nucleotide of the target nucleic acid. The quencher may be non-fluorescent material, to aid spectral resolution of the fluorescent dye. Alternatively, the quencher may be fluorescent so as to be detectable. An exemplary target nucleic acid having a fluorescent dye-quencher pair is a TaqMan™ probe, which relies on activity of the 5′ nuclease. The TaqMan™ probe emits a fluorescent signal in proportion to the amount of a known double-stranded DNA during amplification (see U.S. Pat. No. 5,538,848, U.S. Pat. No. 5,804,375, and U.S. Pat. No. 6,358,679).

Examples of fluorescent dyes include fluorescein, rhodamine (see U.S. Pat. No. 5,366,960, U.S. Pat. No. 5,936,087, and U.S. Pat. No. 6,051,719), cyanines (see U.S. Pat. No. 6,080,868, and WO 97/45539), and a metal porphyrin complex (see WO 88/04777). Examples of fluorescein include 6-carboxylfluorescein (6-FAM) represented by Formula 1 below, 2′,4′,1,4,-tetrachlorofluoroscein (TET) represented by Formula 2 below, 2′,4′,5′,7′,1,4-hexachlorofluoroscein (HEX) represented by Formula 3 below (see U.S. Pat. No. 5,654,442), 2′,7′-dimethoxy-4′,5′-dichloro-6-carboxyrodamine (JOE) represented by Formula 4 below, 2′-chloro-5′-fluoro-7′,8′-fused phenyl-1,4-dichloro-6-carboxyfluorescein represented by Formula 5 below (see U.S. Pat. No. 5,188,934 and U.S. Pat. No. 5,885,778), and 2′-chloro-7′-phenyl-1,4-dichloro-6-carboxyfluorescein represented by Formula 6 below (see U.S. Pat. No. 6,008,379). The fluorescein and rhodamine may include a 1,4-dichloro substituent that is a moiety in a lower portion of the structures of Formulas 5 and 6 below. In addition, the fluorescent dye may be Cy3 or Cy5.

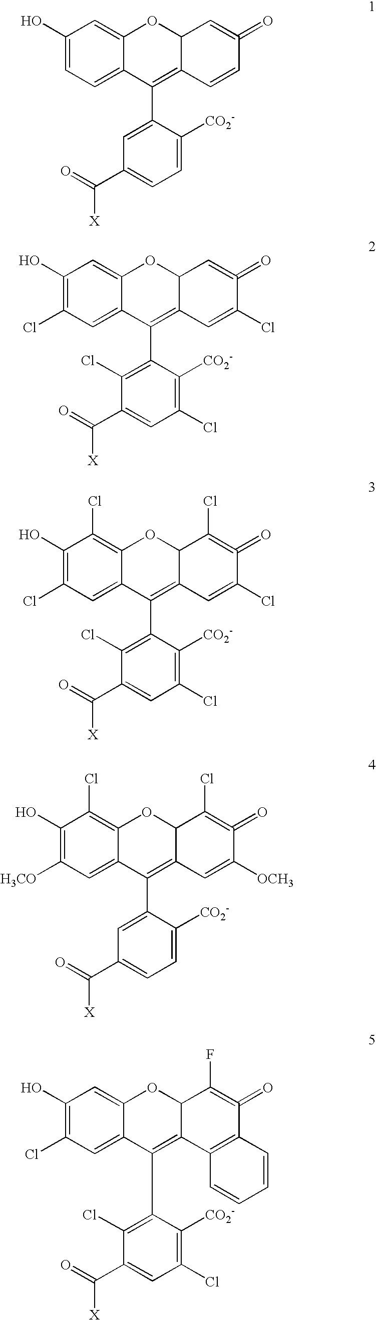

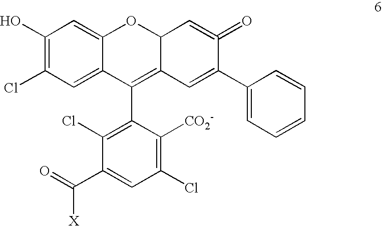

In the above formulae, X is a site through which the fluorescent dye binds to the probe nucleic acid.

Examples of a quencher include: a rhodamine fluorescent dye selected from the group comprising tetramethyl-6-carboxyrhodamine (TAMRA) represented by Formula 7 below and tetrapropano-6-carboxyrhodamine (ROX) represented by Formula 8 below; diazo compounds such as compounds represented by Formulae 9-11 below; and a cyanine dye selected from the group comprising a compound represented by Formula 11 below, anthraquinone, malachite green, nitrothiazole and nitroimidazole. However, the quencher is not limited to the compounds described above.

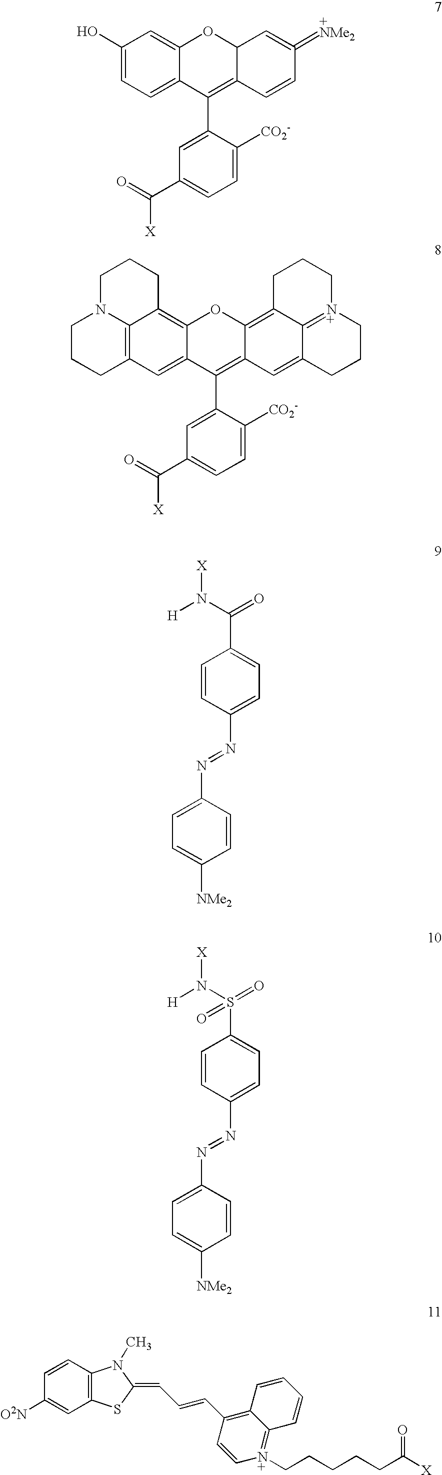

In the above formulae, X is a site through which the quencher dye binds to the probe nucleic acid. [0023] The target nucleic acid may be completely complementary to the probe nucleic acid, and the length of the target nucleic acid may identical to the length of the probe nucleic acid. The probe nucleic acid length is an intended length of the probe nucleic acid when it is synthesized. That is, although, among synthesized probe nucleic acids, the length of some probe nucleic acids can be greater or smaller than the intended length due to errors occurring in the synthesis process, these longer or shorter probe nucleic acids are not considered as the intended length.

The hybridization may be performed under nucleic-acid hybridization conditions that are known in the art. For example, a nucleic acid can be placed in a buffer at 4° C. for 14 hours. The hybridization may be performed under non-stringent conditions or stringent conditions. In general, when a probe nucleic acid is synthesized in situ by photolithography, a probe nucleic acid having an incorrect base, in addition to longer or shorter probe nucleic acids, can be formed. Accordingly, by performing hybridization in non-stringent conditions, the probe nucleic acid having an incorrect base can also be hybridized.

As a result of hybridization, the probe nucleic acid is hybridized with the target nucleic acid to form a double-stranded nucleic acid. In this case, when a shorter probe nucleic acid in which at least one nucleotide is missing due to errors in the synthesis process is hybridized with the target nucleic acid that is completely complementary to the intended probe nucleic acid and has the same length as the intended length of the probe nucleic acid, there is a higher possibility that the 3′ end or 5′ end of the target nucleic acid remains single stranded due to for example, a lack of pairing partner, instability in forming a double strand caused by a wrong base incorporation, etc. That is, when a probe nucleic acid is bound to a substrate through the 3′ end, and a probe nucleic acid that is shorter than the intended length is hybridized with a target nucleic acid, the 3′ end of the target nucleic acid may remain as a 3′ overhang nucleotide. Alternatively, when a probe nucleic acid is bound to a substrate through the 5′ end, and a probe nucleic acid that is shorter than the intended length is hybridized with a target nucleic acid, the 5′ end of the target nucleic acid may remain as a 5′ overhang nucleotide. The 3′ overhang nucleotide and 5′ overhang nucleotide of the target nucleic acid can be cleaved by 3′ or 5′ exonuclease.

A method according to an embodiment of the present invention also includes reacting the hybridization product with at least one enzyme selected from 3′ exonuclease and 5′ exonuclease to remove the detectable signal material from the at least one end. The at least one end of the target nucleic acid remains unpaired with the probe nucleic acid.

Herein, the 3′ exonuclease and 5′ exonuclease may be individual enzymes or part of an enzyme complex. The reaction may be conducted for example, in 0.002X SDS reagent in 4XSSC buffer at a pH of about 7-8. This reaction condition may be compatible to hybridization conditions. Therefore, the exonuclease treatment can be performed simply by adding exonuclease solution to the hybridization reaction solution. Alternatively, after the hybridization and a washing process, the exonuclease treatment can be performed.

The exonuclease may be a DNA polymerase for self-replication used in an organism, or a recombinant variant of the DNA polymerase. Exonuclease examples include E.coli DNA polymerase 1, the Klenow fragment, phi29 DNA polymerase, vent DNA polymerase, T4 DNA polymerase, and T7 DNA polymerase. Since a precursor material required for DNA polymerization is not supplied to the reaction solution or because there is no need to supply the precursor material, exonuclease activity may be present in the same enzyme that has DNA polymerase activity. The exonuclease may be a single strand specific exonuclease.

Due to the exonuclease reaction, the signal material attached to the 3′ or 5′ overhang of the target nucleic acid is removed. Therefore, when the exonuclease is reacted to the hybridization product having a 3′ or 5′ overhang of the target nucleic acid, the intensity of a signal generated is smaller or larger than that of when exonuclease is not used or when exonuclease is reacted to the hybridization product having no 3′ or 5′ overhang of the target nucleic acid. The decrease or increase in signal intensity can be analyzed to examine the quality of an array of probe nucleic acids.

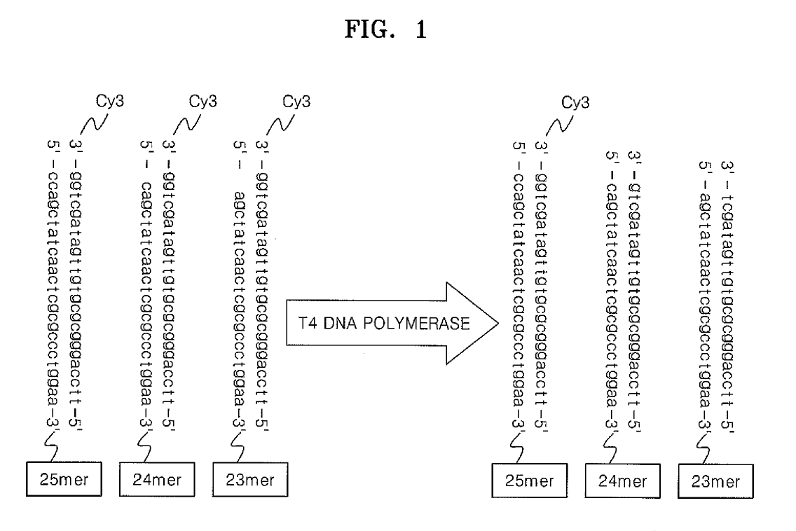

FIG. 1 is a schematic view in which a signal material attached to a 3′ overhang of the target nucleci acid is removed by an exonuclease. Referring to FIG. 1, when a probe nucleic acid immobilized on a substrate is hybridized to a target nucleic acid and T4 DNA polymerase is reacted with the hybridization product, fluorescent material Cy3 attached to the 3′ end is removed by cleaving the 3′ overhang.

According to an embodiment of the present invention, when a probe nucleic acid is immobilized on a substrate at a 3′ end, 3′ exonuclease may be used; on the other hand, when a probe nucleic acid is immobilized on a substrate at a 5′ end, 5′ exonuclease may be used. In both cases, after the probe nucleic acid is hybridized with the target nucleic acid, the probe nucleic acid may be protected from activity of the exonuclease.

An exemplary embodiment of the present invention also includes measuring a residual signal generated from the enzyme reaction product, comparing the measured signal value with a signal value generated from a control group experiment, and analyzing the sequence accuracy of the probe nucleic acid immobilized in the microarray. The residual signal generated from the enzyme reaction product is the signal generated from the residual hybridization product after the detectable signal material attached to the 3′ end or 5′ end is removed by cleaving 3′ overhang or 5′ overhang. The signal may be a fluorescence signal or a radioactive signal.

In the comparing step, when the measured signal value is equal to or less than a predetermined level of the signal value obtained from the control group experiment, the comparing process may further include determining that the probe nucleic acid of the microarray is defective. Specifically, the measured signal value is compared with the control group signal value, and when the measured signal value is equal to or less than the predetermined level of the control group signal value, it is determined that the probe nucleic acid of the microarray is defective. For example, when the measured signal value is equal to or less than about 90%, 80%, or 70% of the control group signal value, it is determined that the microarray is defective. In this case, the signal can be directly obtained from a fluorescent signal material.

In the comparing step, when the measured signal value is equal to or larger than a predetermined level of the control group signal value, the comparing process may further include determining that the probe nucleic acid of the microarray is defective. Specifically, the measured signal value is compared with the control group signal value, and when the measured signal value is equal to or larger than the predetermined level of the control group signal value, it is determined that the probe nucleic acid of the microarray is defective. For example, when the measured signal value is equal to or larger than 110%, 120%, or 130% of the control group signal value, it is determined that the microarray is defective. In this case, the signal can be obtained from a self-quenching signal material.

The control group experiment can be performed in the same manner as described above, except that the reacting step is not used. The control signal is generated from the hybridization product. Alternatively, the control group experiment can be performed in the same manner as described above, except that the probe nucleic acids in the microarray are synthesized using a method of more accurately synthesizing a nucleic acid than that of the microarray to be tested, or the sequence accuracy of the probe nucleic acids is predermined by using a known method, such as nucleic acid sequencing. Such a method may include synthesizing a probe nucleic acid in a liquid or solid phase, and spotting the accurately synthesized probe nucleic acids to the substrate to form the microrray.

Embodiments of present invention will be described in further detail with reference to the following examples. These examples are for illustrative purposes only and are not intended to limit the scope of an embodiment of the present invention.

### EXAMPLE 1

Probe nucleic acids having nucleotide sequences as set forth in SEQ ID NOS: 1-10 (having the length of 25, 24, 23, 21, 19, 17, 15, 13, 11, and 9 bp for each) were obtained from Bioneer Co. (Korea). The 3′ ends of the probe nucleic acids were modified with an aminohexyl group, and the modified probe nucleic acids were spotted onto a surface of a substrate coated with gamma-aminopropyltriethoxysliane (GAPTES) in intervals of about 200 μm to about 300 μm with a spotter (Catesion Co). The concentration of each probe nucleic acid was 12 nM, 160 nM, 0.8 μM, 4 μM, and 20 μM, respectively. In addition, a mixture of probe nucleic acids having nucleotide sequences as set forth in SEQ ID NOS: 1-10 was spotted in a mixture ratio of SEQ ID NO: 1: SEQ ID NO: 2: SEQ ID NO: 3: SEQ ID NO: 4: SEQ ID NO: 5: SEQ ID NO: 6: SEQ ID NO: 7: SEQ ID NO: 8: SEQ ID NO: 9: SEQ ID NO: 10=10 μl: 9μl: 8 μl: 7 μl: 6 μl: 5 μl: 4 μl: 3 μl: 2 μl: 1 μl (hereinafter, a mixture having this mixture ratio will be referred to as a ‘high mix’), 5 μl: 5 μl: 5 μl: 5 μl: 5 μl: 5 μl: 5 μl: 5 μl: 5 μl: 5 μl (hereinafter, a mixture having this mixture ratio will be referred to as an ‘even mix’), and 1 μl: 2 μl: 3 μl: 4 μl: 5 μl: 6 μl: 7 μl: 8 μl: 9 μl: 10 μl (hereinafter, a mixture having this mixture ratio will be referred to as a ‘low mix’). Each probe nucleic acid was spotted on the substrate in triplicate. The concentration of the low mix, the even mix, and the high mix refers to a concentration of all probe nucleic acids having SEQ ID NOS: 1 to 10.

Then, these probe nucleic acids were hybridized with a target nucleic acid having SEQ ID NO: 11 that was completely complementary to SEQ ID NO: 1, in which the target nucleic acid was labeled with Cy3 at the 3′ end. The hybridization was performed in 6X SSC (150 mM NaCl, 15 mM sodium citrate) buffer (pH 7.0) containing about 0.002% SDS and about 10 nM target nucleic acid at about 4° C. for about 12 hours. The hybridization product was washed with 2X SSC (150 mM NaCl, 15 mM sodium citrate) buffer containing about 0.002% SDS.

Then, 3 units of T4 DNA polymerase were added to the hybridization reaction solution so that a 3′ end nucleotide was cleaved from a hybridization product having 3′ overhang by 3′-5′ exonuclease activity of T4 DNA polymerase. Then, the resultant product was exposed to an excitation light having a wavelength of about 552 nm and the absorption of emitted light having a wavelength of about 570 nm was measured using a generated Axxon Scanner.

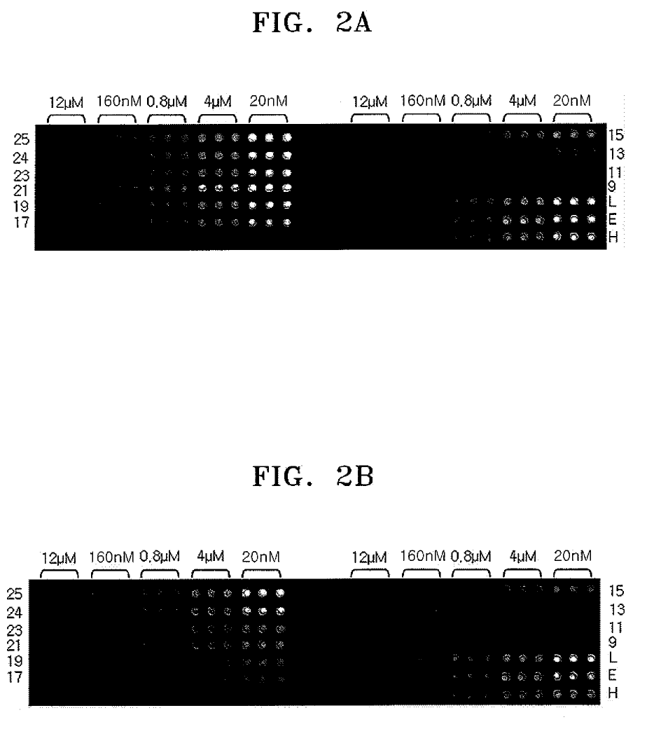

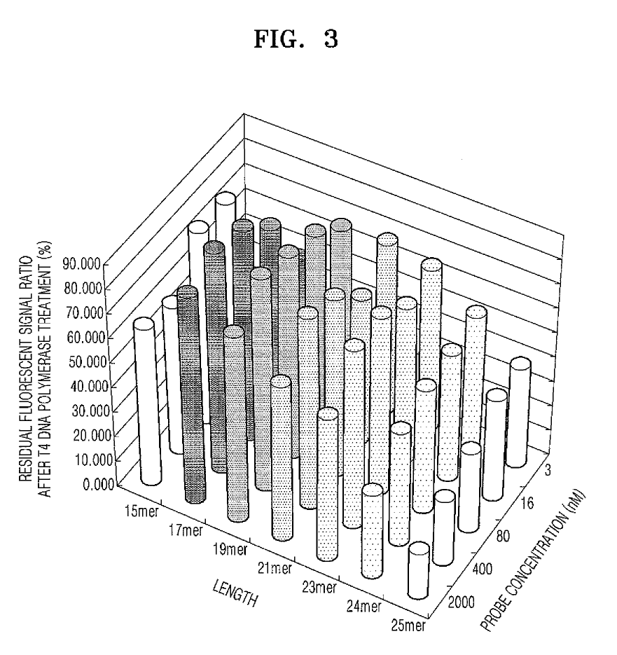

FIG. 2A shows fluorescence measurement results of a control microarray.

FIG. 2B shows fluorescence measurement results of a microarray treated with T4 DNA polymerase.

Referring to FIGS. 2A and 2B, as the length of the probe nucleic acids decreases, the intensity of a fluorescence signal generated from the 25 mer target nucleic acid decreases. In addition, when T4 DNA polymerase was used (3 units: FIG. 2B), the intensity of the fluorescent signal decreased than when T4 DNA polymerase was not used (FIG. 2A). Therefore, it can be seen that 3′ overhang of the target nucleic acid can be cleaved from the hybridization product of the probe nucleic acid and the target nucleic acid by T4 DNA polymerase.

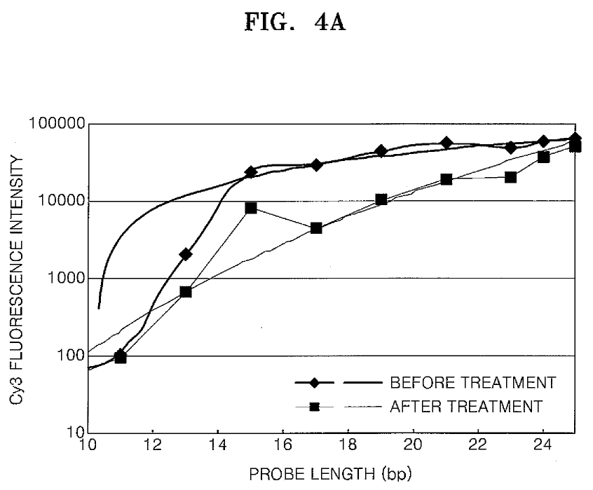

FIG. 3 is a graph of a T4 DNA polymerase treatment effect with respect to the spotting concentration and length of probe nucleic acids, based on the results shown in FIG. 2B. In FIG. 3, the vertical axis denotes the decrease in intensity of a fluorescent signal with respect to a control group that was not treated with T4 DNA polymerase. Referring to FIG. 3, as the length of the probe nucleic acids was decreased, the degree of intensity decrease of the fluorescent signal was increased. Specifically, an intensity decrease of a fluorescent signal generated from a 15 mer probe nucleic acid was smaller than an intensity decrease of a fluorescent signal generated from a 17 mer probe nucleic acid. Such a result occurs not because the number of 3′ overhang nucleotides was small, but because the length of probe nucleic acids was reduced too much and affected hybridization with the target nucleic acid.

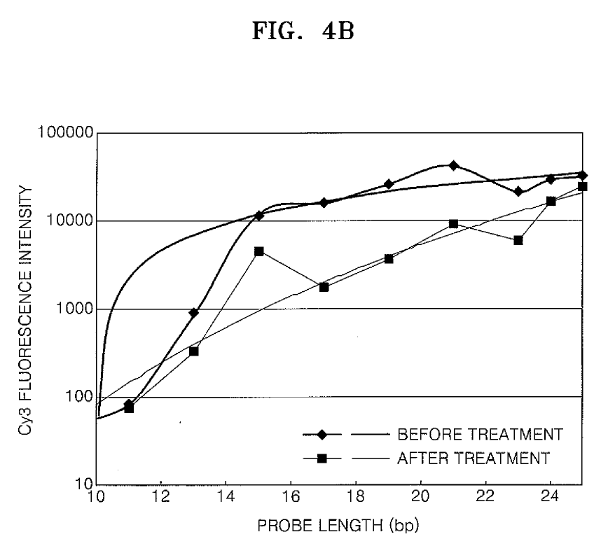

FIGS. 4A and 4B show a change in fluorescence intensity as a function of probe length before and after a T4 DNA polymerase treatment. FIG. 4A shows a change in fluorescence intensity of a microarray in which each probe nucleic acid was spotted at a concentration of about 20 μM before and after the T4 DNA polymerase treatment, and FIG. 4B shows a change in fluorescence intensity of a microarray in which each probe nucleic acid was spotted at a concentration of about 4 μM before and after the T4 DNA polymerase treatment.

In FIG. 4A, the relationship between the length of probe nucleic acids and fluorescent intensity may be expressed using the following equations: before the T4 DNA polymerase treatment, y=2×10⁻⁵×^{6.8548}(R²=0.9356); and after the T4 DNA polymerase treatment, y=4281×⁻⁴³⁶⁰⁴ (R²=0.9447). In FIG. 4B, the relationship between the length of probe nucleic acids and fluorescent intensity may be expressed using the following equations: before the T4 DNA polymerase treatment, y=7×10⁻⁵×^{6.0419} (R²=0.9177); and after the T4 DNA polymerase treatment, y=2353×⁻²³⁶²⁸ (R²=0.7877). Referring to FIGS. 4A and 4B, it can be seen that fluorescent intensity decreased after the T4 DNA polymerase treatment, and a degree of the decrease was more significant as the length of the probe nucleic acids decreased.

As described above, a method of analyzing the accuracy of the sequence of a probe nucleic acid immobilized in a microarray according to an embodiment of the present invention can be used to accurately and simply examine the sequence of a probe nucleic acid immobilized in a microarray.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A method of analyzing an accuracy of a sequence of a probe nucleic acid immobilized in a microarray, the method comprising:
providing a microarray in which regions where a probe nucleic acid is immobilized on a substrate through a 3′ end or a 5′ end are arrayed;
hybridizing the probe nucleic acid with a target nucleic acid that is complementary to the probe nucleic acid to form a hybridization product, wherein the target nucleic acid is labeled with a detectable signal material at at least one end selected from a group comprising a 3′ end and a 5′ end;
reacting the hybridization product with at least one enzyme selected from 3′ exonuclease and 5′ exonuclease to remove the detectable signal material from the at least one end of the target nucleic acid, wherein the at least one end of the target nucleic acid remains unpaired with the probe nucleic acid;
measuring a residual signal generated from the resultant enzyme reaction product;
comparing the measured signal value with a signal value generated from a control group experiment; and
analyzing an accuracy of the probe nucleic acid sequence.

2. The method of claim 1, wherein the probe nucleic acid is immobilized on the substrate through the 3′ end, and the 5′ end of the probe nucleic acid is exposed.

3. The method of claim 1, wherein the probe nucleic acid is immobilized on the substrate through the 5′ end, and the 3′ end of the probe nucleic acid is exposed.

4. The method of claim 1, wherein the signal material is selected from a fluorescent material or a radioactive material.

5. The method of claim 1, wherein the detectable signal material comprises a signal generating material and a quencher, wherein
at least one end selected from 3′ and 5′ ends of the target nucleic acid is labeled with the signal generating material, and the other end of the target nucleic acid is labeled with the quencher, wherein,
when the quencher is removed by the exonuclease, a signal is generated.

6. The method of claim 4, wherein the fluorescent material is selected from Cy3 and Cy5.

7. The method of claim 1, wherein the length of the target nucleic acid is the same as an intended length of the probe nucleic acid.

8. The method of claim 1, wherein the probe nucleic acid is synthesized on the substrate by photolithography.

9. The method of claim 1, wherein the exonuclease is a single strand specific exonuclease.

10. The method of claim 1, wherein the exonuclease is selected from a group comprising a DNA polymerase I, a Klenow fragment and a T4 DNA polymerase.

11. The method of claim 1, wherein the control group experiment is performed using the method of claim 1, except that the reacting step is not used

12. The method of claim 1, wherein the control group experiment is performed using the method of claim 1, except for use of a microarray in which a probe nucleic acid that has been synthesized in a liquid phase is immobilized by spotting.

13. The method of claim 1, wherein, when the measured signal value is equal to or less than a predetermined level of a signal value obtained from the control group experiment, the comparing step further comprises determining that the probe nucleic acid of the microarray is defective.

14. The method of claim 1, wherein, when the measured signal value is equal to or greater than a predetermined level of a signal value obtained from the control group experiment, the comparing step further comprises determining that the probe nucleic acid of the microarray is defective

15. A method of analyzing an accuracy of a sequence of a probe nucleic acid immobilized in a microarray, the method comprising:
providing a microarray in which regions where a probe nucleic acid is immobilized on a substrate through a 3′ end or a 5′ end are arrayed;
hybridizing the probe nucleic acid with a target nucleic acid that is complementary to the probe nucleic acid to form a hybridization product, wherein the target nucleic acid is labeled with a detectable signal material, wherein the detectable signal material comprises a signal generating material and a quencher, wherein at least one end selected from 3′ and 5′ ends of the target nucleic acid is labeled with the signal generating material, and the other end of the target nucleic acid is labeled with the quencher;
reacting the hybridization product with at least one enzyme selected from 3′ exonuclease and 5′ exonuclease to remove the detectable signal material from the target nucleic acid, wherein at least one end of the target nucleic acid remains unpaired with the probe nucleic acid, and wherein, when the quencher is removed by the exonuclease, a residual signal is generated
measuring said residual signal generated from the resultant enzyme reaction product;
comparing the measured residual signal value with a signal value generated from a control group experiment; and
analyzing an accuracy of the probe nucleic acid sequence.

16. The method of claim 15, wherein the target nucleic acid is labeled with said detectable signal material at at least one end selected from a group comprising a 3′ end and a 5′ end, and the detectable signal material is removed from the at least one end of the target nucleic acid.

17. A method of analyzing an accuracy of a sequence of a probe nucleic acid immobilized in a microarray, the method comprising:
providing a microarray in which regions where a probe nucleic acid is immobilized on a substrate through a 3′ end or a 5′ end are arrayed;
hybridizing the probe nucleic acid with a target nucleic acid that is complementary to the probe nucleic acid to form a hybridization product, wherein a length of the target nucleic acid is the same as an intended length of the probe nucleic acid, and the target nucleic acid is labeled with a detectable signal material at at least one end selected from a group comprising a 3′ end and a 5′ end;
reacting the hybridization product with at least one enzyme to remove the detectable signal material from the at least one end of the target nucleic acid, wherein the at least one end of the target nucleic acid remains unpaired with the probe nucleic acid;
measuring a residual signal generated from the resultant enzyme reaction product;
comparing the measured signal value with a signal value generated from a control group experiment; and
analyzing an accuracy of the probe nucleic acid sequence.

18. The method of claim 17, wherein the at least one enzyme is selected from 3′ exonuclease and 5′ exonuclease.


SEQUENCE LISTING (13 sequences)

SEQ ID NO: 1 - DNA, 25 bp, Artificial Sequence
  25 mer probe
ccagctatcaactcgcgccctggaa

SEQ ID NO: 2 - DNA, 24 bp, Artificial Sequence
  24mer probe
cagctatcaactcgcgccctggaa

SEQ ID NO: 3 - DNA, 23 bp, Artificial Sequence
  23mer probe
agctatcaactcgcgccctggaa

SEQ ID NO: 4 - DNA, 21 bp, Artificial Sequence
  21mer probe
ctatcaactcgcgccctggaa

SEQ ID NO: 5 - DNA, 19 bp, Artificial Sequence
  19mer probe
atcaactcgcgccctggaa

SEQ ID NO: 6 - DNA, 17 bp, Artificial Sequence
  17mer probe
caactcgcgccctggaa

SEQ ID NO: 7 - DNA, 15 bp, Artificial Sequence
  15mer probe
actcgcgccctggaa

SEQ ID NO: 8 - DNA, 13 bp, Artificial Sequence
  13mer probe
tcgcgccctggaa

SEQ ID NO: 9 - DNA, 11 bp, Artificial Sequence
  11mer probe
gcgccctggaa

SEQ ID NO: 10 - DNA, 9 bp, Artificial Sequence
  9mer probe
gccctggaa

SEQ ID NO: 11 - DNA, 25 bp, Artificial Sequence
  25mer target complementary to the 25mer probe labelled with Cy3 at its 3′ terminus
ttccagggcgcgtgttgatagctgg

SEQ ID NO: 12 - DNA, 24 bp, Artificial Sequence
  24mer target derived from 25mer target labelled with Cy3 at it′s3′terminus
ttccagggcgcgtgttgatagctg

SEQ ID NO: 13 - DNA, 23 bp, Artificial Sequence
  23mer target derived from 25mer target labelled with Cy3 at its 3′ terminus.
ttccagggcgcgtgttgatagct